(19) United States
(12) Patent Application Publication
(10) Pub. No.: US 2025/0055489 A1
(43) Pub. Date: Feb. 13, 2025

(54) EMBEDDED MULTIPATH MODEL FOR WIRELESS SYSTEMS

(71) Applicant: SKYWORKS SOLUTIONS, INC., Irvine, CA (US)

(72) Inventors: Hussein Hijazi, Cork (IE); Amit Kumar, Portland, OR (US)

(21) Appl. No.: 18/796,832

(22) Filed: Aug. 7, 2024

Related U.S. Application Data
(60) Provisional application No. 63/531,661, filed on Aug. 9, 2023.

(51) Int. Cl. H04B 1/04; H04B 1/00; H04B 1/12

(52) U.S. Cl. CPC H04B 1/0483; H04B 1/0057; H04B 1/12

(57) ABSTRACT

According to at least one aspect of the present disclosure a multipath system is provided, the system comprising: an input configured to receive an input signal; an output configured to provide an output signal; at least one summing node coupled to the output; and one or more multipath units coupled to the input and to the at least one summing node, the one or more multipath units configured to apply a delay to the input signal and to apply a gain to the input signal using one or more coefficients shaped according to a spectrum.

### CROSS-REFERENCE TO RELATED APPLICATIONS

This application claims priority under 35 U.S.C. § 119(e) to U.S. Provisional Patent Application 63/531,661, titled EMBEDDED MULTIPATH MODEL FOR WIRELESS SYSTEMS, filed on Aug. 9, 2023, and hereby incorporated by reference in its entirety for all purposes.

### BACKGROUND

Wireless communication devices, such as cell phones, routers, radios, and so forth, are designed to receive and/or transmit data wirelessly. Wireless transmitting and receiving can follow multiple paths due to signals reflecting off objects and surfaces between the transmitter and the receiver. For example, signals can bounce off the ground, buildings, walls, furniture, the sky, and so forth. This creates multiple paths for a given signal to take from transmitter to receiver. However, while the signals may each contain the same data, certain paths are longer than other paths. For example, any reflected path will generally be longer than a direct path (a direct path is a “straight-line” path from transmitter to receiver that does not contain any reflectors or other obstacles that would reflect the signal). Thus, the same data may be received at multiple points in time by the receiver because the different paths are different lengths and thus out of phase with one another.

### SUMMARY

According to at least one aspect of the present disclosure a multipath system is provided, the system comprising: an input configured to receive an input signal; an output configured to provide an output signal; at least one summing node coupled to the output; and one or more multipath units coupled to the input and to the at least one summing node, the one or more multipath units configured to apply a delay to the input signal and to apply a gain to the input signal using one or more coefficients shaped according to a spectrum.

In some examples, each multipath unit of the one or more multipath units further comprises: a fractional delay component configured receive the input signal and to apply the delay to the input signal; a multipath gain coefficient register coupled to a first multiplier and configured to provide at least one gain coefficient to the first multiplier; a filter configured to generate at least one filter coefficient and provide the at least one filter coefficient to the first multiplier; a second multiplier coupled to the first multiplier, the fractional delay component, and the output; and an output configured to provide an output signal based on the delay, the at least one gain coefficient, and the at least one filter coefficient. In some examples, the first multiplier is configured to multiply the at least one gain coefficient with the at least one filter coefficient. In some examples, the multipath system further comprises one or more parameter registers including a multipath update interval register. In some examples, the system of further comprises memory, the memory containing the one or more coefficients. In some examples, the system further comprises at least one switching device configured to selectively activate and deactivate the one or more multipath units. In some examples, the system further comprises a plurality of switching devices, each multipath unit of the one or more multipath units coupled to a respective switching device of the plurality of switching devices, each respective switching device configured to selectively activate and deactivate at least one of the one or more multipath units. In some examples, the multipath units are configured to operate on baseband frequencies. In some examples, the input or output are configured to downconvert signals from carrier frequencies to DC or low frequencies.

According to at least one aspect of the present disclosure, a testing system for testing behaviors of a device in one or more multipath environments is provided, the testing system comprising: a device including an input, an output, a switching device, and a multipath system; and a controller configured to be coupled to the input and the output.

In some examples, the multipath system further comprises: an input; an output; a summing node coupled to the output; a multiplier coupled to the input and to the summing node; and one or more multipath units coupled to the summing node. In some examples, each multipath unit of the one or more multipath units comprises: a fractional delay component coupled to a first multiplier and a delay register; an output coupled to the first multiplier; a multipath gain register coupled to a second multiplier, the second multiplier being further coupled to the first multiplier; a filter coupled to the second multiplier and to a random number generator; and one or more parameter registers.

According to at least one aspect of the disclosure, a method of modeling a multipath environment is provided, the method comprising: determining a movement rate of a device; configuring one or more parameters corresponding to a state of the multipath environment; responsive to configuring the one or more parameters, providing an input signal to the device; responsive to providing the input signal to the device, receiving an output signal from the device; and analyzing one or more attributes of the output signal to determine the effect of the multipath environment on the device.

In some examples, the one or more parameters include at least one member of a set including: an update interval; a direct path gain; a multipath gain; an RF channel of the input signal; a transmitting antenna characteristic; and a receiving antenna characteristic.

According to at least one aspect of the present disclosure, a programmable multipath modeling circuit is provided, the circuit comprising: a transmit node (TX node) configured to be coupled to a transmit connection (TX connection); a receive node (RX node) configured to be coupled to a receive connection (RX connection); at least one multipath module; a first MUX coupled to the TX node, the RX node, and the at least one multipath module; a second MUX coupled to the TX node, the at least one multipath module, and a digital-to-analog converter (DAC); a third MUX coupled to the RX node, the at least one multipath module, and an RX decimator stage; and a controller configured to control a first state of the first MUX, control a second state of the second MUX, and control a third state of the third MUX.

In some examples, the first MUX is coupled to the second MUX and third MUX; and the second MUX is coupled to the third MUX. In some examples, the circuit further comprises at least one additional programmable multipath modeling circuit coupled in parallel with the programmable multipath modeling circuit between the TX connection, RX connection, DAC, and RX decimator stage.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a multipath system according to an example;

FIG. 2 illustrates a multipath unit according to an example;

FIG. 3A illustrates a multipath test system according to an example;

FIG. 3B illustrates a multipath test system according to an example; and

FIG. 4 illustrates a process for configuring a multipath system according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Testing equipment may emulate multipath environments. The testing equipment can emulate multipath fading, which is a phenomena caused by a signal at a receiver being composed of a number of reflections of a transmitted signal. In general, multipath environments are tested by simply moving the receiver around through an environment and testing the receiver as it is moved. However, testing in this way is difficult because live environments can be unpredictable and are difficult to control for testing purposes.

Systems and methods disclosed herein emulate multipath environments in a cabled setup. That is, instead of wheeling a receiver around a test environment (such as a warehouse or factory), the receiver is plugged into a cable that provides a signal to the receiver, and the receiver automatically converts the input signal into a plurality of signals emulating a multipath environment. This method makes it easy to control the test environment and eliminates many of the logistical challenges of the traditional testing method. The emulation circuitry can be located entirely on the receiver, eliminating the need of using any external converter device to perform the emulation. Furthermore, in contrast to existing test systems, the multipath systems discussed herein may be implemented directly on the communications device or communications chip that will be used in a product, such as a cellphone. That is, the multipath systems disclosed herein are not necessarily part of laboratory testing equipment or other external equipment.

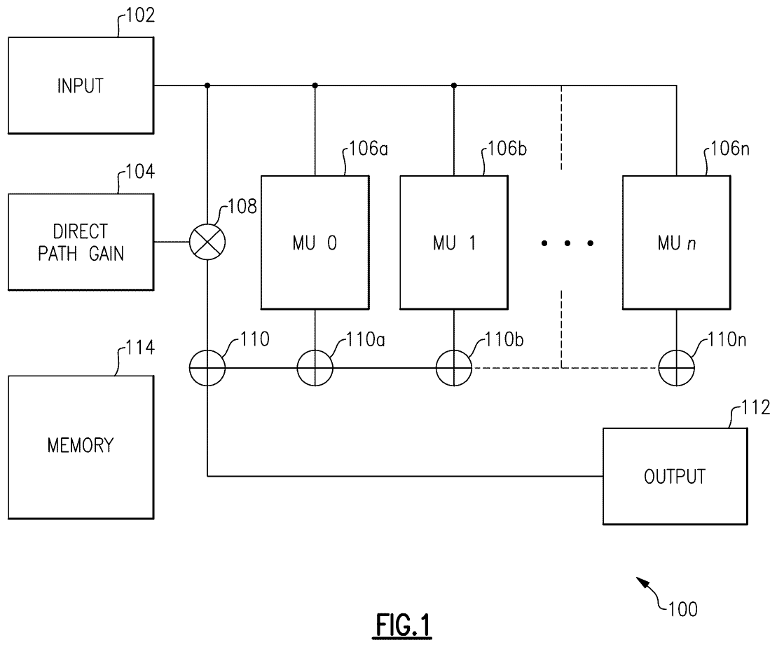

FIG. 1 illustrates a multipath system 100 for emulating a multipath environment according to an example. The multipath system 100 includes an input 102, a direct path gain input 104 (“direct path gain 104”), a plurality of multipath units 106a-n, including a first multipath unit 106a, a second multipath unit 106b, and an nth multipath unit 106n. The multipath system 100 includes a multiplier 108 and a plurality of summing nodes 110, 110a-n, including summing node 110, first summing node 110a, second summing node 110b, and nth summing node 110n. The multipath system 100 includes an output 112 and memory 114.

The input 102 is coupled to the multiplier 108 and each of the multipath units of the plurality of multipath units 106a-n. The direct path gain 104 is coupled to the multiplier 108. Each multipath unit of the plurality of multipath units 106a-n is coupled to a respective summing node of the plurality of summing nodes 110a-n. For example, the first multipath unit 106a is coupled to the first summing node 110a, the second multipath unit 106b is coupled to the second summing node 110b, and so on, including the nth summing node 106n being coupled to the nth summing node 110n. The first summing node 110a is coupled to the summing node 110, as is the multiplier 108. The summing node 110 is coupled to the output 112. The memory 114 may be configured to provide coefficients, weights, taps, or other values to the multipath units 106a-n.

The input 102 is configured to receive an input signal. The input signal may be a data-carrying signal, such as a telecommunications signal, or may be a test waveform. The input signal can be a digital signal (that is, discrete rather than continuous). The input 102 can provide the input signal to the multiplier 108 and any of the multipath units 106a-n.

The direct path gain 104 is an input configured to receive a value (for example, a 4, 6, 8, or 12-bit value, or any other number of bits) corresponding to the gain coefficient for the direct path. In some examples, the direct path is a path between the antenna that would originate the input signal in an analog (or non-test) environment and the receiver (e.g., the communications device the multipath system 100 is collocated with). Accordingly, the gain coefficient may be any value greater than or equal to zero. The direct path gain 104 can provide the gain coefficient to the multiplier 108. In some examples, the direct path gain 104 may be a register or other memory capable of receiving, providing, and storing the gain coefficient.

The multiplier 108 multiplies the value of the input signal from the input 102 with the gain coefficient from the direct path gain 104 to produce an adjusted input signal. The adjusted input signal may be greater than or less than the input signal from the input 102. The multiplier 108 provides the adjusted input signal to the summing node 110.

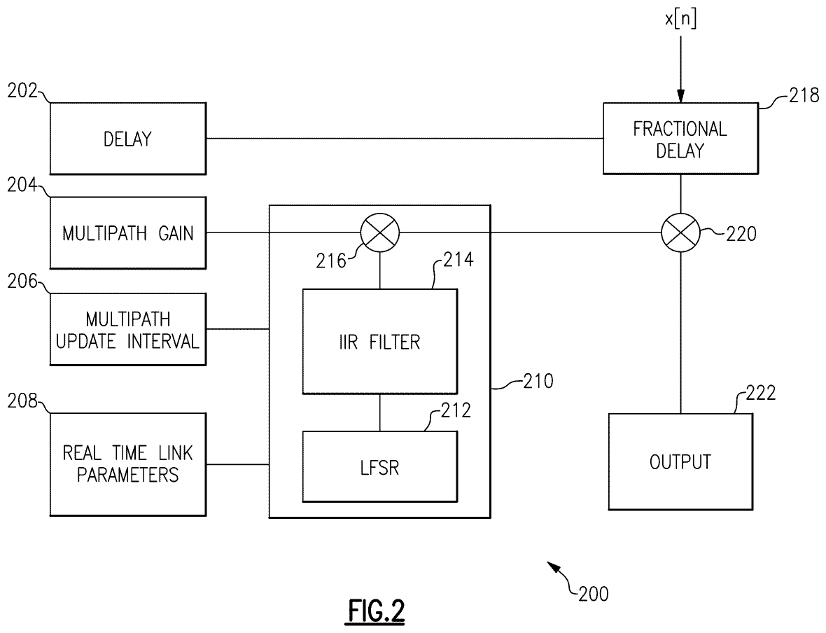

Each multipath unit 106a-n can also receive the input signal. The multipath units 106a-n may be switchable—that is, some multipath units 106a-n may be turned on at any given time, and others may be turned off. Each multipath unit 106a-n operates in the same basic way. The multipath units 106a-n receive the input signal from the input 102, modify the input signal to produce respective multipath signals, and provide the respective multipath signals to respective summing nodes 110a-n. The multipath units 106a-n modify the input signal by providing a delay to the input signal, providing a multipath gain to the input signal, and updating the multipath signal at intervals of time (that may be uniform or non-uninform). The multipath units 106a-n may also provide filtering (e.g., spectrum shaping) to the input signal, and may also include configurable parameters for antennas, RF channels, and so forth. The multipath units 106a-n will be discussed in greater detail with respect to FIG. 2.

The summing nodes 110, 100a-n sum the respective multipath signals and adjusted input signal together to produce an output signal, and provide the output signal to the output 112. The output signal, as the sum of the adjusted input signal and multipath signals, represents the effects of various paths on the original input signal, and therefore emulates a real-world multipath environment.

The output 112 is an output configured to provide the output signal to any connected device. The output 112 may be a wired or wireless connection.

In some examples, the number of multipath units 106a-n may be greater than one. For example, to model three paths, for example a direct path, a path reflecting off the ground, and a path reflecting off the sky, three multipath units may be included. In other examples, six, eight, ten, or more multipath units may be included to model different kinds of multipath environments.

FIG. 2 illustrates a multipath unit 200 according to an example. The multipath unit 200 can emulate one or more paths between a transmitter and a receiver (for example, a transmitting antenna and a receiving antenna). As illustrated, the multipath unit 200 can emulate one path at a time, but can be configured such that the path being emulated can be modified and changed to represent a different path. In some examples, the configuration of the multipath unit 200 may be altered during operating, for example, to emulate changing paths as a device collocated with the multipath unit 200 is moved around.

The multipath unit 200 includes a delay register 202, a multipath gain register 204, a multipath update interval register 206, real-time link parameter registers 208 (“RTLP registers 208”), a fading coefficient generator 210, a fractional delay component 218, a second multiplier 220, and an output 222. The fading coefficient generator 210 includes a linear feedback shift register (LFSR) 212, an infinite impulse response (IIR) filter 214, and a first multiplier 216.

The delay register 202 is coupled to the fractional delay component 218. The multipath gain register 204 is coupled to the first multiplier 216. The multipath update interval register 206 is coupled to the fading coefficient generator 210. The RTLP registers 208 are coupled to the fading coefficient generator 210. The LFSR 212 is coupled to the IIR filter 214. The IIR filter 214 is coupled to the first multiplier 216. The first multiplier 216 is coupled to the multipath gain register 204, the IIR filter 214, and to the second multiplier 220. The second multiplier 220 is coupled to the fractional delay component 218 and to the output 222.

The delay register 202 contains a value, represented in bits, for a fractional delay to be applied to an input signal by the fractional delay module 218. The delay register 202 may be configurable, such that the fractional delay value can be adjusted or changed by a user (such as an end user or a computer system with access to the register).

The multipath gain register 204 contains a gain coefficient, represented in bits, for a gain or attenuation to be applied to a signal at the first multiplier 216. The multipath gain register 204 may provide the gain coefficient to the multiplier 216. The gain coefficient may, in some examples, be any value greater than or equal to zero. The gain coefficient may be a real-number value (as opposed to a complex number value). The multipath gain register 204 may also be configurable.

The multipath update interval register 206 contains an update value corresponding to how often the fading coefficient generator 210 should calculate (that is, generate) a coefficient. The multipath update interval register 206 may provide the update value to the fading coefficient generator 210 and may be configurable as well.

The RTLP registers 208 contain one or more registers storing parameters associated with real-time links. Real-time links may be, for example, a connection between a transmitting and receiving antenna on a given RF channel. The RTLP registers 208 may include registers corresponding to the transmitter antenna, the receiver antenna, the RF channel of the communications being modeled, and so forth. The RTLP registers 208 may provide the parameters to the fading coefficient generator 210. Each combination of parameters and/or values for the parameters may correspond to a state of the IIR filter 214.

The fading coefficient generator 210 generates fading coefficients that will be provided to the second multiplier 220. The fading coefficients are applied to the output of the fractional delay component 218 to produce the output signal for the multipath unit 200. The fading coefficients may be complex numbers (e.g., have an imaginary component). The fading coefficients can also have a distinct spectrum, based on the filtering provided by the IIR filter 214. In particular, the spectrum of the fading coefficients may be a Doppler Spectrum, and may be defined by the following characterizations:

$$Maximum Doppler Shift = {f}_{d} = {f}_{c} \frac{v}{c} \qquad ( 1 )$$

$$S ( f ) = \frac{1}{π \sqrt{{f}_{d}^{2} - {f}^{2}}} , if \vert f \vert < {f}_{d} , else 0 \qquad ( 2 )$$

where S(f) is the spectral density of the spectrum of the fading coefficients, c is the speed of light, and v is velocity (of the communications signal).

The fractional delay component 218 receives an input signal (x[n] in FIG. 2) and delays the input signal for a period of time (for example, the fractional delay component 218 may function as a sample and hold circuit, or may function as a shift-register holding a value for a period of time). The fractional delay component 218 provides a delayed input signal to the second multiplier 220.

The second multiplier 220 multiplies the delayed input signal of the fractional delay component 218 with the fading coefficient of the fading coefficient generator 210 to produce an output signal, and provides the output signal to the output 222.

The output 222 can provide the output signal to external devices or to a node (e.g., a summing node 110, 110a-n) of the multipath system 100 of FIG. 1.

Within the fading coefficient generator 210, the LFSR 212 may provide a complex value or a series of complex values to the IIR filter 214. The complex values generated by the LFSR 212 may be random or pseudorandom, and may have a mean of zero with a normalized variance.

The IIR filter 214 shapes the spectrum of the outputs of the LFSR 212. The IIR filter 214 may use a plurality of coefficients to shape the spectrum of the outputs of the LFSR 212, and those coefficients (or taps) may be provided by memory and/or storage (e.g., memory 114). The IIR filter 214 provides a spectrum shaped output signal based on the output of the LFSR 212 and the coefficients to the first multiplier 216.

The first multiplier 216 multiplies the multipath gain by the spectrum shaped output signal and provides the resulting signal to the second multiplier 220.

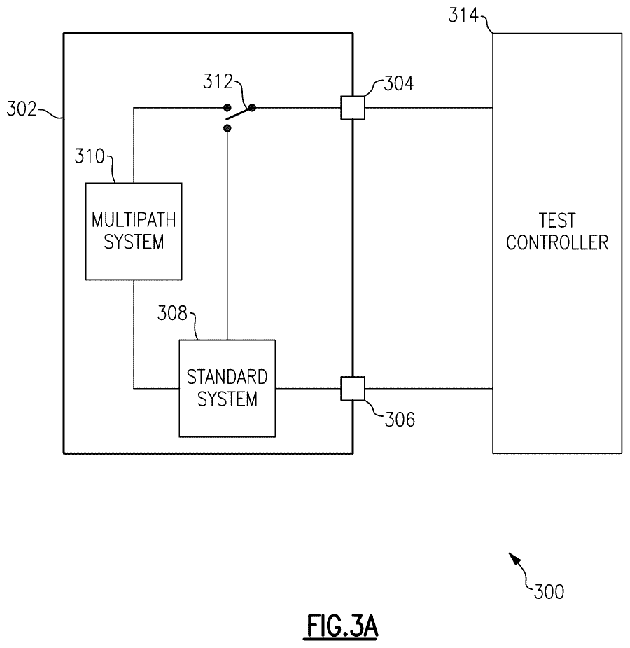

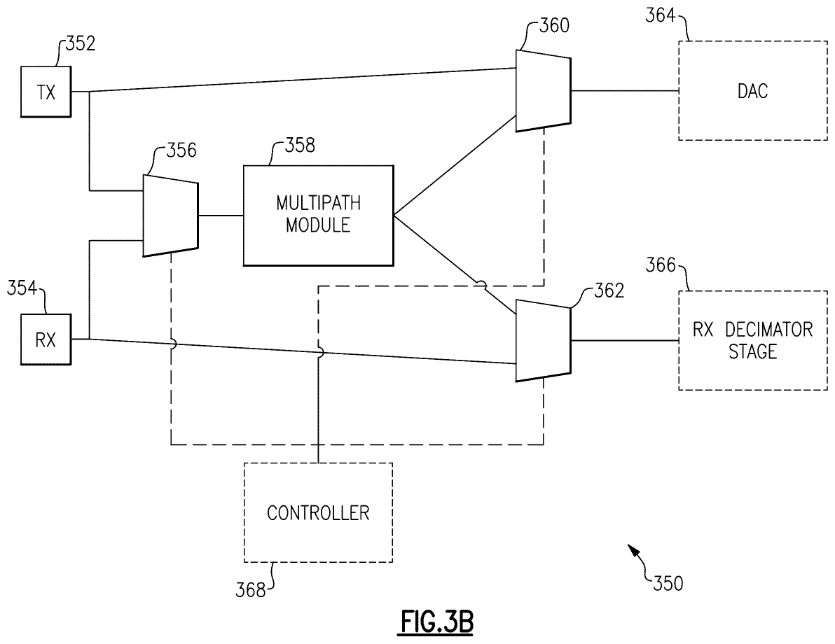

FIG. 3A illustrates a system 300 for testing a device 302 according to an example. The system 300 can use the multipath system 310 to emulate a multipath environment, for example as part of a test protocol. The system 300 includes a device 302, a test controller 314, an input 304, an output 306, a standard system 308, a multipath system 310, and a switching device 312.

The test controller 314 is coupled to the input 304 at a first connection and to the output 306 at a second connection. The input is connected to a first terminal of the switching device 312. The multipath system 310 is connected to a second terminal of the switching device 312 at a first connection and to the standard system 308 at a second connection. The standard system 308 is coupled to a third terminal of the switching device 312 at a first connection, to the output 306 at a second connection, and to the multipath system 310 at a third connection.

The device 302 may be a telecommunications device capable of sending and/or receiving communication signals. In some examples, the device 302 may be a component of a telecommunications device, such as a chip meant for wireless communication. The device 302 includes the standard system 308, the switching device 312, and the multipath system 310.

The input 304 is configured to receive a communications signal. In some examples, the input 304 may be configured to receive an emulated communications signal provided by the test controller 314 for test purposes.

The output 306 is configured to provide an output signal generated by the multipath system 310 or standard system 308. The output signal may be provided to a test controller 314 for analysis and testing purposes.

The standard system 308 is a communications system without the multipath units of the multipath system 310. For example, the standard system 308 may be a circuit that can process incoming and outgoing communication signals without emulating a multipath environment.

The multipath system 310 can emulate multipath environments when a communications signal is provided to the multipath system 310 via the input 304 and the switching device 312. The multipath system 310 may be implemented using the multipath system 100 of FIG. 1.

The switching device 312 is configured to select between providing signals (whether received at the input 304 or output 306) to both the multipath system 310 and the standard system 308, or providing the signals to only the standard system 308. The switching device 312 may be a relay, transistor, 2-or-3-pole switch, and so forth. In some example, the switching device 312 may have at least two states, including a first state wherein signals (whether received at the input 304 or the output 306) are processed through both the multipath system 310 and standard system 308, and a second state wherein signal are processed through only the standard system 308.

In some examples, the multipath system 310 and standard system 308 may be one omnibus system. For example, the multipath system 310 can be integrated into the standard system 308, and the switching device 312 may represent one or more switching devices that can be used to either enable or disable the functionality of the multipath system 310.

The test controller 314 is configured to provide a communications signal to the input 304 and receive an output signal from the output 306. The test controller 314 may also provide control signals to the multipath system 310 to control the configuration of the multipath system 310, including individual multipath units within the multipath system 310.

During testing procedures, the test controller 314 controls the switching device 312 to select (that is, to enable) the multipath system 310. The test controller 314 also provides configuration parameters to the multipath system 310 to configure the multipath system 310 to emulate a given multipath environment. The test controller 314 can also dynamically adjust the configuration parameters of the multipath system 310 to model changes in the multipath environment and/or to create other multipath environments. The test controller 314 can receive an output signal from the output 306. The output signal may be provided by the multipath system 100 and may reflect the effect of the multipath environment being emulated by the multipath system 100 on the communications signal provided at the input 304. The test controller 314 may be connected via physical connections (e.g., wires) to the input 304 and output 306, thus insulating the test communication signal and output signal (and the multipath system 100) from some or all external interference (e.g., noise, stray signals, and so forth).

FIG. 3B illustrates the internal configuration of a device 350 according to an example. The device 350 may be a telecommunications device capable of sending and receiving signals, and may selectively implement the multipath test environment described herein.

The device 350 includes a TX input 352, an RX input 354, a first multiplexer (MUX) 356, a multipath module 358, a second MUX 360, and a third MUX 362. The device 350 may include various optional components, including a digital-to-analog converter (DAC) 364, an RX decimator stage 366, and a controller 368.

The TX input 352 is coupled to the first MUX 356 and to the second MUX 360. The RX input 354 is coupled to the first MUX 356 and the third MUX 362. The first MUX 356 is coupled to the TX input 352 at a first connection, the RX input 354 at a second connection, and the multipath module 358 at a third connection. The multipath module 358 is coupled to the first MUX 356 at a first connection, and to the second MUX 360 and third MUX 362 at a second connection. The second MUX 360 is coupled to the TX input 352 at a first connection, the multipath module 358 at a second connection, and the DAC 364 at a third connection. The third MUX 362 is coupled to the multipath module 358 at a first connection, the RX input 354 at a second connection, and the RX decimator stage 366 at a third connection. The controller 368 may be coupled to the first MUX 356, the second MUX 360, and the third MUX 362. In some examples, the controller 368 may be coupled to each MUX at a respective select input of each MUX, allowing the controller 368 to control the output of each MUX.

The TX input 352 is configured to receive signals to be transmitted (TX signals), and provide said signals to the first MUX 356 and second MUX 360.

The RX input 354 is configured to receive signals transmitted from other devices (RX signals) and provide those signals to the first MUX 356 and the third MUX 362.

The multipath module 358 is configured to process TX and RX signals such that the TX and RX signals are altered as though received or transmitted along multiple paths. In some examples, the multipath module 358 may be implemented using the topology described with respect to the multipath system 100 for emulating a multipath environment described with respect to FIG. 1. The multipath module 358 receives unaltered TX and RX signals from the first MUX 356 at an input, processes those signals, and then provides the processed TX signals to the second MUX 360 and/or the processed RX signals to the third MUX 362.

The first MUX 356 receives TX signals at a first input and RX signals at a second input. The first MUX 356 may provide either or both of the TX and RX signals to the multipath module 358.

The second MUX 360 receives an unaltered TX signal at a first input and a processed TX or RX signal at a second input. The second MUX 360 may provide the unaltered TX signal or the processed TX or RX signal to the DAC 364.

The third MUX 362 receives an unaltered RX signal 354 at a first input and a processed TX or RX signal at a second input. The third MUX 362 may provide the unaltered RX signal or the processed TX or RX signal to the RX decimator stage 366.

The DAC 364 converts the signal it receives from digital form to analog form, and can provide the analog signal to an antenna, transmitter, or other device.

The RX decimator stage 366 filters and/or attenuates the signal it receives and can provide the signal to another device or another part of a circuit in which the system 350 is integrated.

The controller 368 can control the state of each MUX. For example, the controller 368 can determine whether the first MUX 356 provides an RX or TX signal to the multipath module 358 (or whether the first MUX 356 is in a high impedance mode, such that no signal is provided to the multipath module 358). The controller 368 can also determine whether the second MUX 360 provides an unaltered TX signal to the DAC 364 or a processed signal to the DAC 364. The controller 368 can also determine whether the third MUX 362 provides an unaltered RX signal to the RX decimator stage 366 or a processed signal to the RX decimator stage 366. In at least one example, if the controller 368 sets both the second MUX 360 and third MUX 362 to provide unprocessed signals (e.g., for the first MUX 360 to provide an unprocessed TX signal to the DAC 364 directly from the TX input 352, and the second MUX 362 to provide an unprocessed RX signal to the RX decimator stage 366 directly from the RX input 354), then the multipath module 358 may be disabled so that it does not use power or energy.

In some examples, the multipath system 100, 310 and/or multipath module 358 may draw a substantial amount of power when in use and may use additional circuitry compared to systems that do not have multipath systems. As a result, the multipath system 100, 310 or multipath module 358 may be enabled during test operations, when power concerns are not an issue (e.g., when the device containing the multipath systems or modules is plugged in to an external power source), and may be disabled during ordinary operations (e.g., when the device is not in a test mode).

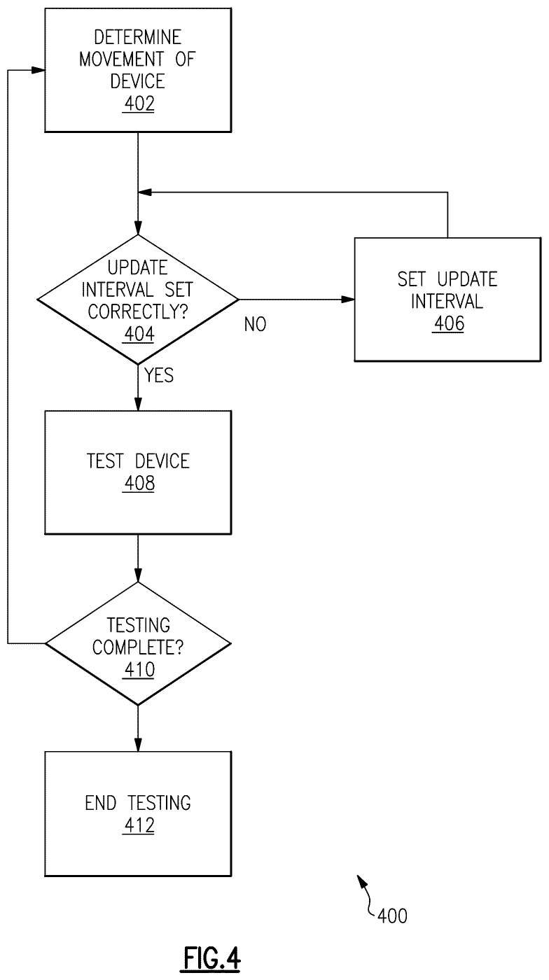

FIG. 4 illustrates a process 400 for testing a device in multipath conditions. The test process can emulate the device being moved physically through an environment without physically moving the device through an environment.

At act 402, a controller (e.g., a user, the test controller 314, and so forth) determine the movement speed of the device-under-test (DUT) (e.g., device 302 of FIG. 3A). The DUT may be, for example, a phone or other telecommunications-capable device. The DUT may not actually be moved. That is, the controller is determining simulated movement of the DUT that can be emulated using the multipath unit in the DUT. The controller may determine constant or variable movement of the DUT. Once the movement is determined, the process 400 may continue to act 404.

At act 404, the controller determines if the update interval is set to the correct value to emulate the desired movement of the DUT. For example, the controller may determine whether the multipath update interval value (e.g., the value stored in the multipath update interval register 206 of FIG. 2) is set to a value that will properly emulate the movement of the DUT in the multipath environment. In some examples, fast update rates correspond to fast movement and slow update rates correspond to slow movement. For example, 100 μs may correspond to the DUT moving at 4 m/s, while an update rate of 100 ms may correspond to the DUT moving at 3 mm/s. If the controller determines that the update interval is set to the correct value (404 YES), the process 400 may continue to act 408. If the controller determines that the update interval is not set to the correct value (404 NO), the process 400 may continue to act 406.

At act 406, the controller sets the update interval. The controller may, for example, set a value in a register corresponding to the update interval (e.g., the multipath update interval register 206 of FIG. 2). The process 400 may then continue to act 404.

At act 408, the controller begins testing of the DUT. The controller can set and/or change the parameters of the DUT, a multipath system within the DUT, or multipath units within the multipath system. The controller may provide input signals to the DUT to be processed by the multipath system within the DUT, and the controller may receive output signals representing the processing performed by the multipath system on the input signals. For example, with reference to FIG. 1, the output signal provided by the output 112 may be the output signal received by the controller. The input signal provided at the input 102 may be the input signal provided by the controller. The process 400 may then continue to act 410.

At act 410, the controller checks whether testing is complete. For example, the controller may determine that testing is not complete because the movement of the DUT should be changed (e.g., to reflect a change in velocity of the DUT in the multipath environment) and/or because the parameters defining the multipath environment should be changed (e.g., to reflect a changing multipath environment or the DUT moving from one environment to another), and so forth. The controller may determine that testing is complete if, for example, the multipath environment has been fully emulated and/or the testing protocol or program has been completed. If the controller determines testing is no complete (410 NO), the process 400 may return to act 402. If the controller determines testing is complete (410 YES), the process 400 may continue to act 412.

At act 412, the controller terminates testing. The controller may control a switch or other control device or setting within the DUT to disable the multipath system. Alternatively, the multipath system may be configured to automatically disable once testing is complete.

With respect to registers mentioned above, such as the multipath gain register 204, multipath update interval register 206, RTLP registers 208, and so forth, these may be implemented using types of memory other than registers. For example, the registers may be replaced with memory such as RAM, ROM, and so forth, that store the values contained in the registers and which may be accessed by devices such as test controller 314 or controller 368, or provided to the multipath systems and modules described herein.

In the foregoing examples, the system may be implemented in baseband. That is, rather than directly implementing the multipath phenomena, which is complicated and difficult, the effects may be modeled in the baseband for the device. In some examples, implementing the systems and methods described herein in baseband means implementing the multipath environment after the communication signal has been downconverted from the carrier frequency to either DC or low-frequency.

Various controllers, such as the test controller 314, may execute various operations discussed above. Using data stored in associated memory and/or storage, the controllers also execute one or more instructions stored on one or more non-transitory computer-readable media, which the controllers may include and/or be coupled to, that may result in manipulated data. In some examples, the controllers may include one or more processors or other types of controllers. In one example, the controllers are or includes at least one processor. In another example, the controllers perform at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

1. A multipath system comprising:
an input configured to receive an input signal;
an output configured to provide an output signal;
at least one summing node coupled to the output; and
one or more multipath units coupled to the input and to the at least one summing node, the one or more multipath units configured to apply a delay to the input signal and to apply a gain to the input signal using one or more coefficients shaped according to a spectrum.

2. The multipath system of claim 1 wherein each multipath unit of the one or more multipath units further comprises:
a fractional delay component configured receive the input signal and to apply the delay to the input signal;
a multipath gain coefficient register coupled to a first multiplier and configured to provide at least one gain coefficient to the first multiplier;
a filter configured to generate at least one filter coefficient and provide the at least one filter coefficient to the first multiplier;
a second multiplier coupled to the first multiplier, the fractional delay component, and the output; and
an output configured to provide an output signal based on the delay, the at least one gain coefficient, and the at least one filter coefficient.

3. The multipath system of claim 2 wherein the first multiplier is configured to multiply the at least one gain coefficient with the at least one filter coefficient.

4. The multipath system of claim 1 wherein the multipath system further comprises one or more parameter registers including a multipath update interval register.

5. The multipath system of claim 1 further comprising memory, the memory containing the one or more coefficients.

6. The multipath system of claim 1 further comprising at least one switching device configured to selectively activate and deactivate the one or more multipath units.

7. The multipath system of claim 6 further comprising a plurality of switching devices, each multipath unit of the one or more multipath units coupled to a respective switching device of the plurality of switching devices, each respective switching device configured to selectively activate and deactivate at least one multipath unit of the one or more multipath units.

8. The multipath system of claim 1 wherein the one or more multipath units are configured to operate on baseband frequencies.

9. The multipath system of claim 1 wherein the input or output are configured to downconvert signals from carrier frequencies to DC or low frequencies.

10. A method of modeling a multipath environment comprising:
determining a movement rate of a device;
configuring one or more parameters corresponding to a virtual state of the multipath environment to determine the virtual state of the multipath environment;
providing an input signal to the device responsive to configuring the one or more parameters;
receiving an output signal from the device responsive to providing the input signal to the device; and
analyzing one or more attributes of the output signal to determine the effect of the multipath environment on the device.

11. The method of claim 10 wherein the one or more parameters include at least one member of a set including:
an update interval;
a direct path gain;
a multipath gain;
an RF channel of the input signal;
a transmitting antenna characteristic; and
a receiving antenna characteristic.

12. The method of claim 10 wherein providing the input signal to the device further includes applying at least one fractional delay to the input signal to produce at least one delayed input signal, and summing the input signal and the at least one delayed input signal.

13. The method of claim 12 further comprising applying a gain to the input signal prior to summing the input signal and the at least one delayed signal, the gain corresponding to a direct path gain of the multipath environment.

14. The method of claim 12 further comprising applying a gain to the at least one delayed input signal prior to summing the input signal and the at least one delayed input signal, the gain corresponding to a multipath gain of the multipath environment.

15. The method of claim 12 further comprising providing at least three fractional delays to the input signal including a first delay corresponding to signal reflections against an upper boundary of the multipath environment, a second delay corresponding to signal reflections against a lower boundary of the multipath environment, and a third delay corresponding to signal reflections against environmental objects in the multipath environment.

16. A programmable multipath modeling circuit comprising:
a transmit node configured to be coupled to a transmit connection;
a receive node configured to be coupled to a receive connection;
at least one multipath module;
a first multiplexer (MUX) coupled to the transmit node, the receive node, and the at least one multipath module;
a second MUX coupled to the transmit node, the at least one multipath module, and a digital-to-analog converter (DAC);
a third MUX coupled to the receive node, the at least one multipath module, and an RX decimator stage; and
a controller configured to control a first state of the first MUX, control a second state of the second MUX, and control a third state of the third MUX.

17. The programmable multipath modeling circuit of claim 16 wherein the first MUX is coupled to the second MUX and third MUX, and the second MUX is coupled to the third MUX.

18. The programmable multipath modeling circuit of claim 17 further comprising at least one additional programmable multipath modeling circuit coupled in parallel with the programmable multipath modeling circuit between the transmit connection, receive connection, DAC, and RX decimator stage.

19. The programmable multipath module circuit of claim 18 wherein the DAC is configured to provide an analog signal to a transmission device.

20. The programmable multipath module circuit of claim 19 wherein the controller is further configured to control a respective state of each MUX such that each MUX provides an unaltered signal at its respective output.
